(19) United States
(12) Patent Application Publication
(10) Pub. No.: US 2009/0166312 A1
(43) Pub. Date: Jul. 2, 2009

(54) BOTTLE SHAPED CONTAINER WITH INTEGRATED SLEEVE

(76) Inventor: Jean-Pierre Giraud, Paris (FR)

Correspondence Address: GREENBERG TRAURIG, LLP, MET LIFE BUILDING, 200 PARK AVENUE, NEW YORK, NY, 10166, US

(21) Appl. No.: 12/095,097

(22) PCT Filed: Dec. 1, 2006
(86) PCT No.: PCT/US06/61528

§ 371 Date: Nov. 12, 2008

Related U.S. Application Data
(60) Provisional application No. 60/741,845, filed on Dec. 1, 2005.

(51) Int. Cl. B65D 43/16; B65D 25/00; B29C 45/00; B32B 37/00

(52) U.S. Cl. 215/235; 215/390; 264/250; 156/69

(57) ABSTRACT

In one embodiment, the present invention comprises a bottle-shaped container comprising at least three components, wherein the first component is injection molded, composed of a desired shape and comprises at least side walls, an opening at a top and a neck portion that connects the side walls to the top; the ratio of a diameter of the opening to a largest length of the inside wall of the bottle is no greater than 0.75; wherein the second component is a sleeve that abuts at least a portion of the inside side walls of the bottle, the sleeve comprises side walls and a bottom section, an outside portion of the sleeve is fixed to at least a portion of inside side walls of the bottle by a notch or lip located at an inside portion of the neck; and wherein the third component is a bottom that abuts an outside portion of the bottom section of the sleeve, a portion of each end of bottom is fixed to a portion of an undercut of a bottom of the bottle side walls.

### BACKGROUND OF THE INVENTION

Many pharmaceutical and nutraceutical products are packaged in bulk containers. Conventionally, these containers are bottle-shaped having substantially cylindrical sides. The bottles are typically manufactured by a process of injection blow molding. In this process, an injection molded preform is formed. Next the preform is stretched (blow molded) over a mandrel to create the final bottle geometry.

Conventionally, the bottles used are composed of plastic, typically high-density polyethylene (HDPE). HDPE is used because of its good molding capabilities, low cost and high moisture barrier properties. Many of products packaged in HDPE bottles are moisture sensitive. A drying agent (referred to as a desiccant) may be incorporated into the bottle during packaging. The desiccant, (e.g. silica gel, molecular sieve or a combination of both) is typically a granular material that is packaged in sachets or canisters. The canister or sachet is dropped into the bottle prior to product filling on the packaging line. The canisters and sachets are available in 1-gram, 2-gram and 3-gram units.

There are disadvantages with the canister or sachet. For example, when placed in a bottle, the desiccant canister or sachet can interfere with product filling. The canister or sachet can cause the product (i.e., a tablet or capsule) to pyramid during filling causing the product to overflow the bottle. For products that require a large quantity of desiccant, the loose canisters and sachets may compete for volume in the package. The desiccant makes it more difficult for the user to access the product. In many cases, the users remove the desiccant from the bottle immediately after opening. Thus, once removed, there is no means to remove moisture from the bottle during product use. This can degrade the product during use. Because the desiccant canister or sachet is loose in the package, the desiccant can be mistakenly ingested by the user.

### SUMMARY OF THE INVENTION

In one embodiment, the present invention comprises a bottle-shaped container comprising at least three components, wherein the first component is injection molded, composed of a desired shape and comprises at least side walls, an opening at a top and a neck portion that connects the side walls to the top; the ratio of a diameter of the opening to a largest length of the inside wall of the bottle is no greater than 0.75; wherein the second component is a sleeve that abuts at least a portion of the inside side walls of the bottle, the sleeve comprises side walls and a bottom section, an outside portion of the sleeve is fixed to at least a portion of inside side walls of the bottle by a notch or lip located at an inside portion of the neck; and wherein the third component is a bottom that abuts an outside portion of the bottom section of the sleeve, a portion of each end of bottom is fixed to a portion of an undercut of a bottom of the bottle side walls.

### BRIEF DESCRIPTION OF DRAWINGS

A more complete appreciation of the present invention and many of the attendant advantages thereof will be readily understood by reference to the following description was considered in connection with the accompanying drawings in which:

FIG. 1 is a cross-sectional view of one embodiment of the bottle-shaped container with liner of the present invention;

FIG. 1A and 1B is a blow-up of one embodiment of the present invention of the FIG. 1;

FIG. 2 is an overhead plan view of one embodiment of the bottle-shaped container with liner of the present invention in an opened position;

FIG. 3 is a cross-sectional view of one embodiment of the bottle-shaped container with liner of the present invention; and

FIG. 4 is a cross-sectional view of one embodiment of the bottle-shaped container with liner of the present invention.

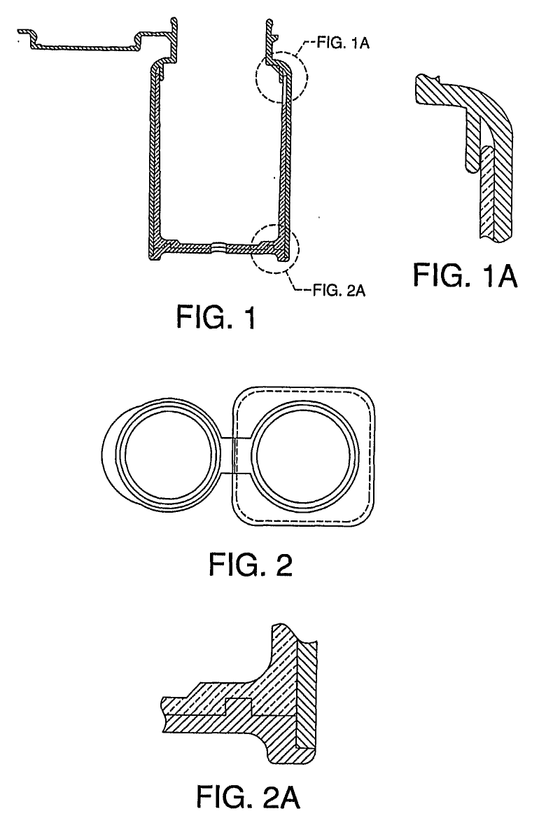

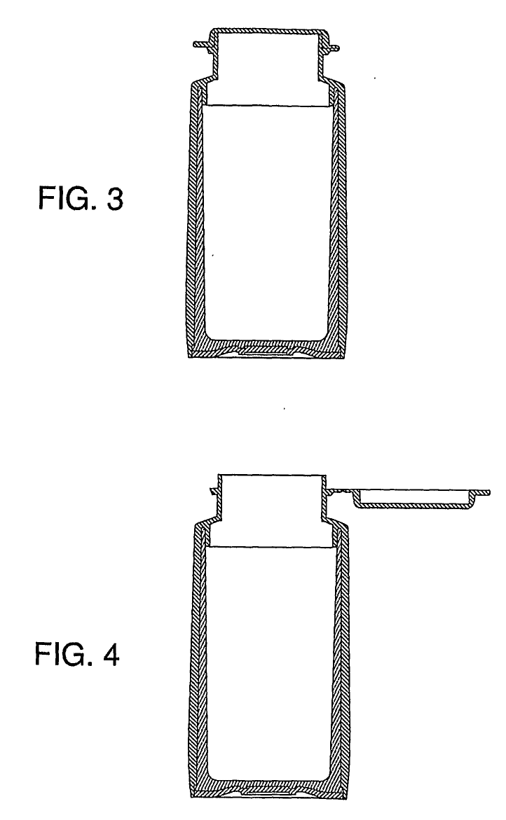

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various embodiments and features thereof

### DESCRIPTION OF EMBODIMENTS OF PRESENT INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

In one embodiment, the present invention is a bottle-shaped container that is manufactured with a sleeve that lines interior surfaces of the container. In one example, the sleeve, composed of plastic, may be composed of an active agent (e.g. desiccant) mixed with a plastic (e.g. desiccant entrained plastic). The desiccant entrained plastic sleeve reduces or eliminates the need for a separate desiccant canister or sachet. One example is a three component composition is the compositions and methods disclosed in one or more of the following U.S. Pat. Nos.: 5,911,937, 6,214,255, 6,130,263, 6,080,350 and 6,174,952, 6,124,006, and 6,221,446. Another example is a two component mixture of active agent and plastic.

In one embodiment, of the process of making the present invention is manufactured in a multi-step injection molding process. For example, this process may incorporate 2-shot molding and include in-mold assembly.

In yet another embodiment, the shape of the bottle of the present invention can be any desired shape. For example, the bottle can be cylindrical or substantially cylindrical. In another example, the bottle can be non-cylindrical bottle geometries (i.e., rectangular, square, oblong, oval). Incorporated in the desired shape of the bottle is a sleeve that has substantially the same shape and dimensions of the interior surface of the container. In yet another embodiment, the top opening of the bottle is less than the overall bottle width (or diameter).

In a further embodiment, the bottle comprises the following elements:
A Closure Region with a diameter that is less than the overall bottle width. The closure region may be finished with a threaded opening (to support a traditional screw-top closure with a foil seal) or plug-type stopper closure. Alternative, the bottle may be molded with an integral flip-top closure. The flip-top provides a substantially moisture-tight re-sealable closure for the bottle.
A Neck (or transition) Region—location where the bottle width transitions from the maximum width to the closure region width.
Product Region—the location defined by the maximum bottle width—the area of the bottle that is filled with product.
Sleeve—a separate molded component that lines the interior surface of the bottle. The sleeve may contain an active agent (e.g desiccant, oxygen absorber, releasing agent) or may be a material that is most suitable as a product contact surface.
Bottom—a separate component that is molded onto the bottom of the bottle after the sleeve has been inserted. The formed bottom closes off the bottom of the vial, creating a sealed end.

In one embodiment, the bottle with the integrated sleeve supports a standard screw-top closure, stopper closure or an integral flip-top lid closure. In one example, the flip-top closure is molded concurrently with the bottle. In a specific example, the flip-top lid creates a substantially moisture-tight resealable closure by closing the lid during the molding process. Examples of flip-top lids designs are described in U.S. Pat. nos. Re 37,676, 4,812,116, and 4,783,056, all of which are incorporated herein by reference. In another example, by closing the flip-top lid in the mold, the sleeve containing an active agent is protected from the ambient environment without additional protective packaging (i.e., barrier bag).

In one example, the sleeve can be made from a variety of materials such as 3 Phase Active-Polymers, barrier or non barrier plastics depending on the requirements of the container. In one specific example, barrier plastics may include, but are not limited to, polyvinyl chloride, polyethylene vinyl acetate and poly vinylidene chloride. In another specific example, non-barrier thermoplastic materials may include, but are not limited to, polystyrene, polyester terephthalate, low-density polyethylene, polypropylene, polybutylene, metallocene catalyzed polyolefins and poly maleic anhydride.

In another embodiment that includes one or more active agents, the active agents may be blended into polymers suitable for injection molding. For example, the amount of active agents in the polymer can range from about 10% to about 70% by weight of the polymer. The total capacity of the active agent can be customize by: (1) varying the sleeve thickness, and/or (2) varying the active agent loading in the polymer.

In one example, the active agents are blended into the polymer by using a compounding process. In a further example, an extruder (e.g., Leistriz Twin-Screw Extruder) can be used to compound the active polymer. In yet another example, the blended material is formed into strands and cut into regular shaped pellets suitable for use in an injection molding process.

Suitable types of active agents (or contact surfaces) include but are not limited to:
Desiccants—e.g. molecular sieves, silica gel, clays, calcium carbonate, etc.
Oxygen absorbers
Odor absorbers
Inert product contact surface—e.g., Teflon—Packaging materials may absorb (or scalping) flavors or active compounds from the product. Specific materials, such as Teflon have been found to be beneficial at minimizes scalping.
Anti-microbial agents

The sleeve is designed to line the interior surface of the bottle. In another example, the sleeve can also be designed and molded with compartments (or partitions) to separate product in the bottle. These compartments may serve several functions, which include but are not limited to: (1) product cushioning—reducing product (tablet) movement in the package and/or (2) compliance—the compartments may be used in conjunction with instructions (or features) on the bottle to insure that the user takes the product at the prescribed time.

In one embodiment, the bottle's top opening size area is no more than 75% of the cross sectional area of the Bottle Product Region (the overall bottle width or outside diameter). In one example, during the second injection, the sleeve is supported by a mold core that fits though the Bottle Opening. In another embodiment, the upper portion of the bottle has features to retain the Sleeve and prevent the Sleeve from moving during the injection of the bottom. For example, clearance between the bottle and the sleeve is maintained in a retaining feature. In another example, the position of the Sleeve in the bottle is controlled by a supporting core through the bottle opening, not by the mechanical fit between the bottle and sleeve.

The bottle top and bottom can be made of a variety of polymers depending on the specific requirements of the container. Suitable materials include, but are not limited to, barrier plastics that may include, for example, polyvinyl chloride, polyethylene vinyl acetate and poly vinylidene chloride. Suitable non-barrier thermoplastic materials may include, but are not limited to, polystyrene, polyester terephthalate, low-density polyethylene, polypropylene, polybutylene, metallocene catalyzed polyolefins and poly maleic anhydride.

In another embodiment, a process that molds the Sleeve in the same mold as the container may contain an undercut feature that is used on the outside bottom surface of the Sleeve so that it is removed from the internal core in the mold when opening. This aids the transfer to the Bottle Top. The undercuts are subsequently filled in when the Bottom is formed.

The present invention may have one or more of the following advantages: can improve product stability during shelf life and use life; create a substantially impenetrable barrier—since the sleeve lines the interior surfaces of the bottle, the product can be well protected because the active agent in the sleeve absorbs materials (i.e., moisture oxygen, etc.) before the materials reach the product; the desiccant (drying agent) is embedded into the sidewalls; the desiccant is not readily visible to the end user; eliminates loose desiccant in the package; the desiccant can not be easily removed; reduces the possibility of the desiccant being ingested; reduces the impact to existing packaging lines—the standard (non-desiccated) bottle and the bottle with integrated desiccant should be able to run on existing packaging line without changes; and/or can customize the amount of desiccant in the bottle, based on the product and/or the climate zone. Moreover, the desiccant can be used to remove residual moisture in the product—the package can eliminate a process step.

The following illustrates one example of the present invention. It is understood that this is merely one example and is not meant to limit the invention to this illustration. This example uses a 2-shot injection molding with a 3-position rotary table. One mold cavity makes the inner lining (sleeve), which may incorporate an active agent in the polymer. The second mold cavity forms the exterior bottle (or container body). Polymers used for the bottle include, but are not limited to: (1) HDPE and (2) Polypropylene. The following is a sequence of operation of the Manufacturing Process:

1. The mold closes in Position 1.

Step 1a—Exterior Bottle Cavity A: The mold injects polyethylene resin to form the flip-top lid (or threaded closure) and exterior sidewalls of the bottle. The exterior base of the bottle is not formed at this time.

Step 1b—Sleeve Cavity B: Simultaneously with Step la, the mold injects a second polymer material into a separate mold cavity to form the bottle sleeve. The sleeve creates an inner sidewall and an inner base.

2. The mold opens.

The exterior bottle w/o base is retained in Cavity A. The sleeve is retained on the core of Cavity B.

3. The core side of the mold rotates 90 degrees to Position 2, so that the Cavity B core (that retains the sleeve) is positioned over Cavity A (that contains the exterior bottle w/o base.
4. The mold closes in Position 2; the sleeve is mechanically transferred to the exterior bottle.
5. The mold opens.
6. The core side of the mold rotates 90 degrees to Position 3.
7. The mold closes in Position 3 and the polyethylene resin is injected into the mold forming a sealed base on the exterior bottle.
8. The mold opens
9. The flip-top lid is closed on to the bottle (not required for screw-top closure)
10. The finished part is ejected from the mold; the core side of the mold and rotates 180 degrees back to Position 1.

The following illustrates another example of the present invention. It is understood that this is merely one example and is not meant to limit the invention to this illustration. This example uses a 2-position stack mold. The container is made by a series of steps. One embodiment is to conduct these steps using a stack mold and a two shot molding machine. The series of steps are as follows—

Step 1—In the first position the polyethylene resin is injected into Cavity A making the Closure Region, Neck Region and Product Region, referred to as the Bottle Top. Simultaneously desiccant plastic is injected into Cavity B and the Sleeve is molded on the opposite side of the stack mold. The Sleeve has an open end and a closed end.
Step 2—the mold opens and the Sleeve is transferred into position on the other side of the mold. Also during this step the mold rotates to the second position.
Step 3—The internal Sleeve is inserted into the Bottle Top with the open end towards the container opening, over a supporting core in the mold.
Step 4—The mold closes and the second injection of polyethylene occurs. The second injection creates the Bottom, and bonds to the Bottle Top creating a substantially moisture tight seal, and locking the Sleeve in place in the container.

During the second injection of the first part, the first injection of the next container is occurring, so that each cycle produces as completed part.

Step 5—The mold opens and the Flip Top lid is closed, creating a reclosable substantially moisture tight seal at the opening of the container.
Step 6 The completed container is ejected from the mold.

The following illustrates yet another example of the present invention. It is understood that this is merely one example and is not meant to limit the invention to this illustration. This example describes one method and sequence of steps to manufacture the container. The container could be manufactured by variations on these steps such as the following.

In Step 1, the Sleeve and the Bottle Top do not need to be injected simultaneously on the same injection molding machine. For example, two machines working in tandem where the Bottle Top and Bottom are made on one machine, and the Sleeve is made on a second machine and transferred to the first machine for insertion in step 3.

Other embodiments of the method include having each step carried out on a separate machine and transferring parts from one to another in the correct sequence, manufacturing the Sleeve in advance and have it inserted into the mold, manufacturing the Sleeve by means other than injection molding, such as blow molding, casting or machining, using the same material for the Sleeve as the Bottle Top and Bottom. A further variation also encompasses Steps 2 and 3 is to use a mold where the Sleeve is molded on the same face of the mold as the Bottle Top and an additional position is utilized to transfer the Sleeve to the Bottle Top. Another variation of Step 2 would be the movement between Position 1 and Position 2 can be a linear shuttling movement. Where Step 5 describes a Flip Top embodiment of the container, a variation of this process also is to use other types of reclosable openings such as threaded or plug seal. In another example, instead of closing the lid, the appropriate geometry on the Bottle Top is created by unthreading or striping out a mold component depending on the desired geometry.

In yet another embodiment, the bottle comprises at least three components, wherein the first component is injection molded, composed of a desired shape and comprises at least side walls, an opening at a top and a neck portion that connects the side walls to the top; the ratio of a diameter of the opening to a largest diameter of an inside side wall of the bottle is no greater than 0.75; wherein the second component is a sleeve that abuts at least a portion of the inside side walls of the bottle, the sleeve comprises side walls and a bottom section, an outside portion of the sleeve is fixed to at least a portion of inside side walls of the bottle by a notch or lip located at an inside portion of the neck; and wherein the third component is a bottom that abuts an outside portion of the bottom section of the sleeve, a portion of each end of bottom is fixed to a portion of an undercut of a bottom of the bottle side walls.

Further examples include one or more of the following: desired shape is cylindrical or non-cylindrical shape; sleeve that is make of desiccant plastic; sleeve that is made of a material suitable as a product contact surface for the product; compartments in the sleeve for cushioning or compliance; integral lid with bottle attached by a hinge; sleeve and/or Base are injection molded; sleeve that is make of oxygen scavenging plastic; sleeve that is incorporates an anti-microbial agent in the plastic; sleeve is manufactured by injection blow molding; and/or sleeve is manufactured by casting.

1. A bottle-shaped container comprising at least three components, wherein the first component is injection molded, composed of a desired shape and comprises at least side walls, an opening at a top and a neck portion that connects the side walls to the top; the ratio of a diameter of the opening to a largest length between opposite inside walls of the bottle is no greater than 0.75; wherein the second component is a sleeve that abuts at least a portion of the inside side walls of the bottle, the sleeve comprises side walls and a bottom section, an outside portion of the sleeve is fixed to at least a portion of inside side walls of the bottle by a notch or lip located at an inside portion of the neck; and wherein the third component is a bottom that abuts an outside portion of the bottom section of the sleeve, a portion of each end of bottom is fixed to a portion of an undercut of a bottom of the bottle side walls.

2. The bottle-shaped container of claim 1 wherein desired shape is a non-cylindrical shape.

3. The bottle-shaped container of claim 2 wherein the sleeve is composed of a desiccant plastic.

4. The bottle-shaped container of claim 3 wherein sleeve that is composed of a material suitable as a product contact surface for the product.

5. The bottle-shaped container of claim 3 wherein the compartments in the sleeve is composed of a material that provides for cushioning.

6. The bottle-shaped container of claim 3 wherein the container comprises an integral lid attached by a hinge.

7. The bottle-shaped container of claim 3 wherein the sleeve and the base are injection molded.

8. The bottle-shaped container of claim 2 wherein the sleeve is composed of an oxygen scavenging plastic.

9. The bottle-shaped container of claim 2 wherein the sleeve is composed of an anti-microbial agent in the plastic.

10. The bottle-shaped container of claim 1 wherein at least one compartment in the sleeves is designed so as to function as package compliance.

11. A method of making a bottle-shaped container comprising the following steps:
molding a bottle sleeve in a first mold, wherein the sleeve creates an inner sidewall and an inner base;
simultaneously, molding a container body in a second mold, wherein the container body forms a lid and an exterior sidewalls;
opening both molds;
retaining both the bottle sleeve and container body in a respective mold cavities of the first and second molds;
rotating the cavity of the first mold so as to position the cavity of the first mold over the cavity of the second mold;
closing the molds so that the sleeve in the cavity of the first mold is transferred to the container body of the second mold; opening the molds;
closing the second mold and injecting a thermoplastic resin into the mold so as to form a sealed base on the exterior sidewalls;
opening the mold; and
ejecting the bottle shaped container from the mold.

12. The bottle shaped container method of claim 1 comprising the additional step:
after opening the mold and prior to ejecting the bottle shaped container, a flip-top lid is closed onto the container body.
